(19) United States
(12) Patent Application Publication
(10) Pub. No.: US 2017/0357755 A1
(43) Pub. Date: Dec. 14, 2017

(54) SYSTEM AND METHOD FOR GENERATING A PERSONAL HEALTH RECORD THROUGH A HANDHELD DEVICE

(71) Applicant: DHRUV SUBRAMANIAN, Bangalore (IN)

(72) Inventor: DHRUV SUBRAMANIAN, Bangalore (IN)

(21) Appl. No.: 15/218,093

(22) Filed: Jul. 25, 2016

(30) Foreign Application Priority Data
Jun. 9, 2016 (IN) 201641019770

(51) Int. Cl. G06F 19/00; G06F 17/30; H04L 29/06

(52) U.S. Cl. CPC G06F 19/322; G06F 19/3406; G06F 19/325; G06F 19/3456; H04L 67/42; H04L 63/102; G06F 17/30867; G06F 19/345; G06F 19/328

(57) ABSTRACT

The embodiments herein provides a system and method for generating personal health records using handheld devices. The system includes a handheld device configured for generating prescriptions and other reports, and an application server configured for storing the generated reports. The handheld device and the application server communicates with each other using a communication network. A concerned medical practitioner inputs the data to the handheld device using an interface such as a mobile application. The data is input using a stylus. The generated personal health records are stored in the application server Which is a cloud platform and is shared with a plurality of authorized third party using a secure sharing mechanism.

### CROSS-REFERENCE TO RELATED APPLICATION

The embodiments herein claim the priority of the Indian Provisional Patent Application with Serial Number: 201641019770 filed on Jun. 9, 2016, with the title, “A SYSTEM AND METHOD FOR GENERATING A PERSONAL HEALTH RECORD THROUGH A HANDHELD DEVICE”, and the content of which is included entirely as reference herein.

### BACKGROUND

### Technical Field

The embodiments herein is generally related to patient management systems. The embodiments herein is particularly related to management of personal health records. The embodiments herein is more particularly related to management of personal health records using handwritten inputs through handheld devices.

### Description of the Related Art

A patient management software is used for maintaining electronic version of a patient medical history, that is maintained by the provider over time, and may include all of the key administrative clinical data relevant to that person's care under a particular provider, including demographics, progress notes, problems, medications, and vital signs, past medical history, immunizations, laboratory data and radiology reports. The patient management software is intended to automate access to information and has the potential to streamline the clinician's workflow. Further, the patient management software also has the ability to support other care-related activities directly or indirectly through various interfaces, including evidence-based decision support, quality management, and outcomes reporting.

However, the existing patient management software only allows the clinicians to enter the data digitally using input devices such as a keypad, mouse, etc. and does not allow clinicians to enter the data manually in a handwriting format. This method may be cumbersome as there would be a requirement to include details about the patient immediately. Further, even with the rapid digitization, the clinicians are inclined towards inputting the details physically.

Hence, there is a need for a system and method that allows the clinicians to enter the details and diagnosis of the patient manually through handwritten inputs in handheld computing devices. Further, there is a need for a system and method for saving the manually entered details of the patient. Still further, there is a need for a system and method for sharing the details entered by the clinician securely.

The above-mentioned shortcomings, disadvantages, and problems are addressed herein and which will be understood by reading and studying the following specification.

### Objects of the Embodiments Herein

The various embodiments herein provide a system and method for generating personal health records for a patient using a handheld device.

The primary object of the embodiments herein is to input diagnosis details and treatment details through handwritten inputs in a handheld device.

Another object of the embodiments herein is to create a collaborative platform for sharing the inputted details.

Yet another object of the embodiments herein is to track the details of a patient using a handheld device.

These and other objects and advantages of the embodiments herein will become readily apparent from the following detailed description taken in conjunction with the accompanying drawings.

### SUMMARY OF THE EMBODIMENTS HEREIN

The various embodiments herein provide a system and method for generating personal health records using handheld devices. The system includes a registration module, a diagnosis module, a prescription module, a treatment module, an accounts module, and a database.

The registration module is configured to register a plurality of patients' data using a handheld device, and the registration module generates a unique registration number for each patient post registration.

The diagnosis module is configured to receive the diagnosis conducted by a medical professional and generate a diagnosis report. Further, the diagnosis report is tagged with the unique registration number of the patient.

The prescription module is configured to capture and store a plurality of details including the medicines inputted by the medical professional. Typically, the medical professional inputs the plurality of details using the handheld device through a touch interface. The prescription module further includes a handwriting recognition module which converts the details inputted by the medical professional to recognizable digital characters.

The treatment module is configured to track a treatment taken by the patients by consuming the prescribed medicines in the prescription, and the treatment module provides a treatment list updated by a caregiver. The updated treatment list is dynamically linked with the unique registration number of the patient.

The accounts module is configured to capture subscription and billing details of the patients, and the accounts module is maintained by a support team of the medical professional. Further, the accounts module is dynamically updated when the patient revisits to meet the medical practitioner incurring an additional fee.

The database is configured to store a plurality of data related to the patients, the medical professionals, and the support team of the medical professionals, wherein the database is located remotely and is accessed using a plurality of database query techniques,

According to an embodiment herein, the handheld device is selected from a group consisting of a smart hone, a palmtop, a tablet, a wearable device, a virtual reality device.

According to an embodiment herein, the registration module further registers the details of concerned third-party such as a caregiver, spouse, parents, children, and a pharmacist.

According to an embodiment herein, the data is input through the handheld device using an application program, and the application program is selected from a group consisting of a mobile application, a web application, an application accessed through a browser, and a native application for the handheld device.

According to an embodiment herein, the inputted patients' data includes patient name, the purpose of the visit, type of visit, personal details such as date of birth, contact details, reference details, and the like.

According to an embodiment herein, the diagnosis module includes a medical history of the patient relevant to the diagnosis, and wherein the diagnosis report is processed using a plurality of methods. The plurality of methods is selected from a group consisting of scanning, uploading, typing, and sharing the physical diagnosis report with the database.

According to an embodiment herein, the information stored in the database includes a plurality of documents of the protocols for each module, rules, and regulations of the hospital, rules and regulations for maintaining the patient management system, patient, and the metadata.

According to an embodiment herein, the personal health records are shared with a third party services using a plurality of communication channels, wherein the plurality of communication channel includes messages, e-mail, collaborative document format, app messaging, and multimedia messaging,

According to an embodiment herein, each of the modules includes an administrator account, a manager account, and a client-side account. The administrator account has the capability to monitor and modifies the plurality of accounts created, and the manager account has limited capabilities and has the flexibility to monitor and modify the accounts created for a single institution, and the client-side account and does not have the ability to modify the details without prior permission from the manager account.

The various embodiments herein provide a computer implemented method for generating a personal health record using a handheld device. The method includes registering a plurality of patients to an application through a registration module, receiving diagnosis details of the patients through a diagnosis module, receiving prescription details of the patients from the medical professional through a treatment module, receiving prescription details of the patients from the medical professional through a treatment module, receiving treatment details of the patient from a treatment module from the patient side as a treatment list, and sharing the generated personal health record to an authorized third-party device securely using a communication medium.

According to an embodiment herein, the registration of the patients includes receiving primary details of the patients and generating a unique patient number.

According to an embodiment herein, the diagnosis is conducted by a medical professional and a diagnosis report is generated. The diagnosis report is tagged with the unique registration number of the patient.

According to an embodiment herein, the medical professional inputs the prescription details through a touch interface of the handheld device in a handwritten format, and the received prescription details are digitized using handwriting recognition process.

According to an embodiment herein, the received treatment details are processed and analyzed for monitoring the patients' condition, and the treatment list is dynamically linked with the unique registration number of the patient.

According to an embodiment herein, the generated personal health records of the plurality of the patients are stored in a database for further processing and analysis, and the database is a remote database.

According to an embodiment herein, the method further includes generating billing and subscription details of the patients using an accounts module, and the billing and subscription are updated dynamically based on the visits of the patients' to the medical professionals.

According to an embodiment herein, the method further includes displaying a plurality of other diagnosis conducted by the medical professional on the handheld device using other applications without causing the patient health record to close.

According to an embodiment herein, the method further includes merging a plurality of diagnosis conducted using the handheld device to the diagnosis details.

The system includes a handheld device configured for generating prescriptions and other reports, and an application server configured for storing the generated reports. The handheld device and the application server communicates with each other using a communication network. A concerned medical practitioner inputs the data to the handheld device using an interface such as a mobile application. The data is input using a stylus or hand. The generated personal health records are stored in the application server which is a cloud platform and is shared with a plurality of authorized third-party using a secure sharing mechanism.

According to an embodiment herein, the handheld device is used by medical practitioners including but not limited to clinicians, surgeons, doctors, nurses, hospital management staff, and the like to enter the details about a patient. The medical practitioners input the details of the patient using a digital input device such as a stylus or a digital pen. The details entered by the medical practitioners are in the form of handwriting. The entered details about the patient are stored in the cloud platform. The stored data is retrieved by the medical practitioners when required and shared with authorized third-party such as a spouse, parents, children, pharmacist and the like.

According to an embodiment herein, a method for generating personal health records is provided. The method includes the following steps. At first, the patient is registered to the application. Once the patient is registered to the application, the hospital staff performs initial diagnosis and generates a diagnosis report using the handheld device. Further, the concerned medical professional inputs the data to the prescription through the stylus which is stored in the prescription module. The treatment followed by the patient is updated on the treatment module for further processing and analysis. Further, the billing details are also updated and a complete personal record for the patient is generated using the handheld device. The personal health record is then shared with the concerned third-party, upon request.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may he made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which

FIG. 1 illustrates a block diagram of a system for generating personal health records using handheld devices, according to an embodiment herein.

FIG. 2 illustrates a block diagram of an application server for generating personal health records using handheld devices, according to an embodiment herein.

FIG. 3 illustrates a flowchart explaining a method for generating personal health records using handheld devices, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for generating personal health records using handheld devices. The system includes a registration module, a diagnosis module, a prescription module, a treatment module, an accounts module, and a database.

The registration module is configured to register a plurality of patients' data using a handheld device, and the registration module generates a unique registration number for each patient post registration.

The diagnosis module is configured to receive the diagnosis conducted by a medical professional and generate a diagnosis report. Further, the diagnosis report is tagged with the unique registration number of the patient.

The prescription module is configured to capture and store a plurality of details including the medicines inputted by the medical professional. Typically, the medical professional inputs the plurality of details using the handheld device through a touch interface. The prescription module further includes a handwriting recognition module which converts the details inputted by the medical professional to recognizable digital characters.

The treatment module is configured to track a treatment taken by the patients by consuming the prescribed medicines in the prescription, and the treatment module provides a treatment list updated by a caregiver. The updated treatment list is dynamically linked with the unique registration number of the patient.

The accounts module is configured to capture subscription and billing details of the patients, and the accounts module is maintained by a support team of the medical professional. Further, the accounts module is dynamically updated when the patient revisits to meet the medical practitioner incurring an additional fee.

The database is configured to store a plurality of data related to the patients, the medical professionals, and the support team of the medical professionals, wherein the database is located remotely and is accessed using a plurality of database query techniques.

According to an embodiment herein, the handheld device is selected from a group consisting of a smartphone, a palmtop, a tablet, a wearable device, a virtual reality device.

According to an embodiment herein, the registration module further registers the details of concerned third-party such as a caregiver, spouse, parents, children, and a pharmacist.

According to an embodiment herein, the data is input through the handheld device using an application program, and the application program is selected from a group consisting of a mobile application, a web application, an application accessed through a browser, and a native application for the handheld device.

According to an embodiment herein, the inputted patients' data includes patient name, the purpose of the visit, type of visit, personal details such as date of birth, contact details, reference details, and the like.

According to an embodiment herein, the diagnosis module includes a medical history of the patient relevant to the diagnosis, and wherein the diagnosis report is processed using a plurality of methods. The plurality of methods is selected from a group consisting of scanning, uploading, typing, and sharing the physical diagnosis report with the database.

According to an embodiment herein, the information stored in the database includes a plurality of documents of the protocols for each module, rules, and regulations of the hospital, rules and regulations for maintaining the patient management system, patient, and the metadata.

According to an embodiment herein, the personal health records are shared with a third-party services using a plurality of communication channels, wherein the plurality of communication channel includes messages, e-mail, collaborative document format, app messaging, and multimedia messaging.

According to an embodiment herein, each of the modules includes an administrator account, a manager account, and a client-side account. The administrator account has the capability to monitor and modifies the plurality of accounts created, and the manager account has limited capabilities and has the flexibility to monitor and modify the accounts created for a single institution, and the client-side account and does not have the ability to modify the details without prior permission from the manager account.

The various embodiments herein provide a computer implemented method for generating a personal health record using a handheld device. The method includes registering a plurality of patients to an application through a registration module, receiving diagnosis details of the patients through a diagnosis module, receiving prescription details of the patients from the medical professional through a treatment module, receiving prescription details of the patients from the medical professional through a treatment module, receiving treatment details of the patient from a treatment module from the patient side as a treatment list, and sharing the generated personal health record to an authorized third-party device securely using a communication medium.

According to an embodiment herein, the registration of the patients includes receiving primary details of the patients and generating a unique patient number.

According to an embodiment herein, the diagnosis is conducted'by a medical professional and a diagnosis report is generated. The diagnosis report is tagged with the unique registration number of the patient.

According to an embodiment herein, the medical professional inputs the prescription details through a touch interface of the handheld device in a handwritten format, and the received prescription details are digitized using handwriting recognition process.

According to an embodiment herein, the received treatment details are processed and analyzed for monitoring the patients' condition, and the treatment list is dynamically linked with the unique registration number of the patient.

According to an embodiment herein, the generated personal health records of the plurality of the patients are stored in a database for further processing and analysis, and the database is a remote database.

According to an embodiment herein, the method further includes generating billing and subscription details of the patients using an accounts module, and the billing and subscription are updated dynamically based on the visits of the patients' to the medical professionals.

According to an embodiment herein, the method further includes displaying a plurality of other diagnosis conducted by the medical professional on the handheld device using other applications without causing the patient health record to close.

According to an embodiment herein, the method further includes merging a plurality of diagnosis conducted using the handheld device to the diagnosis details.

The system includes a handheld device configured for generating prescriptions and other reports, and an application server configured for storing the generated reports. The handheld device and the application server communicates with each other using a communication network. A concerned medical practitioner inputs the data to the handheld device using an interface such as a mobile application. The data is input using a stylus or hand. The generated personal health records are stored in the application server which is a cloud platform and is shared with a plurality of authorized third-party using a secure sharing mechanism.

According to an embodiment herein, the handheld device is used by medical practitioners including but not limited to clinicians, surgeons, doctors, nurses, hospital management staff, and the like to enter the details about a patient. The medical practitioners input the details of the patient using a digital input device such as a stylus or a digital pen. The details entered by the medical practitioners are in the form of handwriting. The entered details about the patient are stored in the cloud platform. The stored data is retrieved by the medical practitioners when required and shared with authorized third-party such as a spouse, parents, children, pharmacist and the like.

According to an embodiment herein, a method for generating personal health records is provided. The method includes the following steps. At first, the patient is registered to the application. Once the patient is registered to the application, the hospital staff performs initial diagnosis and generates a diagnosis report using the handheld device. Further, the concerned medical professional inputs the data to the prescription through the stylus which is stored in the prescription module. The treatment followed by the patient is updated on the treatment module for further processing and analysis. Further, the billing details are also updated and a complete personal record for the patient is generated using the handheld device. The personal health record is then shared with the concerned third-party, upon request.

The embodiments herein provide a system and method for generating personal health records using handheld devices. The system includes a registration module, a diagnosis module, a prescription module, a treatment module, an accounts module, and a database.

The registration module is configured to register a plurality of patients' data using a handheld device, and the registration module generates a unique registration number for each patient post registration.

The diagnosis module is configured to receive the diagnosis conducted by a medical professional and generate a diagnosis report. Further, the diagnosis report is tagged with the unique registration number of the patient.

The prescription module is configured to capture and store a plurality of details including the medicines inputted by the medical professional. Typically, the medical professional inputs the plurality of details using the handheld device through a touch interface. The prescription nodule further includes a handwriting recognition module which converts the details inputted by the medical professional to recognizable digital characters.

The treatment module is configured to track a treatment taken by the patients by consuming the prescribed medicines in the prescription, and the treatment module provides a treatment list updated by a caregiver. The updated treatment list is dynamically linked with the unique registration number of the patient.

The accounts module is configured to capture subscription and billing details of the patients, and the accounts module is maintained by a support team of the medical professional. Further, the accounts module is dynamically updated when the patient revisits to meet the medical practitioner incurring an additional fee.

The database is configured to store a plurality of data related to the patients, the medical professionals, and the support team of the medical professionals, wherein the database is located remotely and is accessed using a plurality of database query techniques.

According to an embodiment herein, the handheld device is selected from a group consisting of a smartphone, a palmtop, a tablet, a wearable device, a virtual reality device.

According to an embodiment herein, the registration module further registers the details of concerned third-party such as a caregiver, spouse, parents, children, and a pharmacist.

According to an embodiment herein, the data is inputted using the handheld device using an application program, and the application program is selected from a group consisting of a mobile application, a web application, an application accessed through a browser, and a native application for the handheld device.

According, to an embodiment herein, the inputted patients' data includes patient name, the purpose of the visit, type of visit, personal details such as date of birth, contact details, reference details, and the like.

According to an embodiment herein, the diagnosis module includes a medical history of the patient relevant to the diagnosis, and wherein the diagnosis report is processed using a plurality of methods. The plurality of methods is selected from a group consisting of scanning, uploading, typing, and sharing the physical diagnosis report with the database.

According to an embodiment herein, the information stored in the database includes a plurality of documents of the protocols for each module, rules, and regulations of the hospital, rules and regulations for maintaining the patient management system, patient, and the metadata.

According to an embodiment herein, the personal health records are shared with a third-party services using a plurality of communication channels, wherein the plurality of communication channel includes messages, e-mail, collaborative document format, app messaging, and multimedia messaging.

According to an embodiment herein, each of the modules includes an administrator account, a manager account, and a client-side account. The administrator account has the capability to monitor and modifies the plurality of accounts created, and the manager account has limited capabilities and has the flexibility to monitor and modify the accounts created for a single institution, and the client-side account and does not have the ability to modify the details without prior permission from the manager account.

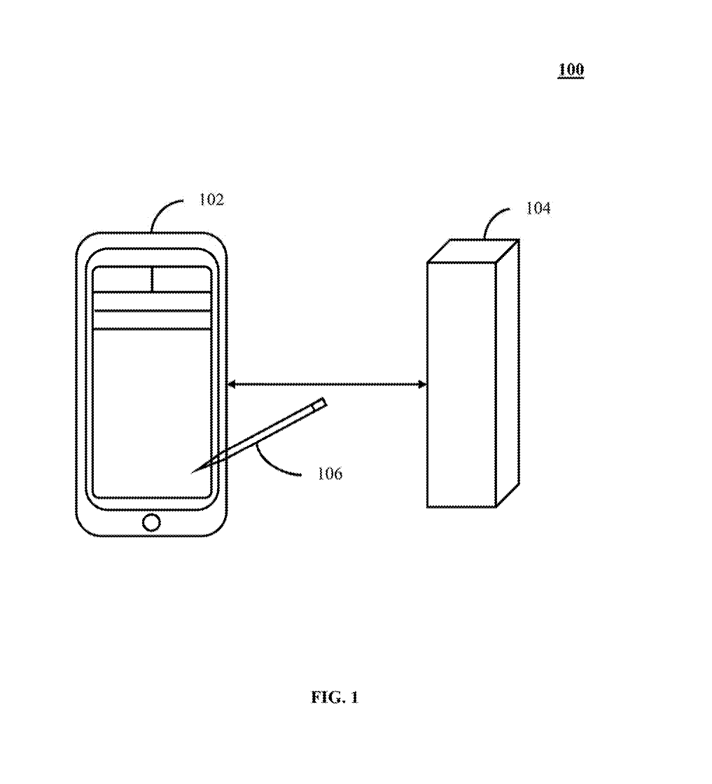

FIG. 1 illustrates a system diagram for generating personal health records using handheld devices, according to one embodiment herein. The system diagram includes a handheld device 102, and an application server 104 hosted on a cloud platform. Typically, the handheld device 102 is used by medical practitioners including, but not limited to clinicians, surgeons, doctors, nurses, hospital management staff, and the like to enter the details about a patient. The medical practitioners input the details of the patient using a digital input device 106 such as a stylus. The details entered by the medical practitioners are in the form of handwriting. The entered details of the patient are stored in the application server 104. The stored data is retrieved by the medical practitioners when required.

The handheld device 102 is a device with a touchscreen. According to an embodiment herein, the medical practitioners input the data using the stylus 106. The examples of the handheld device include, but are not limited to a smartphone, a palmtop, a tablet, a wearable device, a virtual reality device, and the like. The interface for inputting the data is provided using a plurality of ways. The examples of the interface for inputting the patient data include, but are not limited to a mobile application, a web application, an application accessed through a browser, a native application for the handheld device, and the like.

The application server 104 is a cloud platform that stores the data inputted by the medical practitioners. The application server 104 also allows concerned personnel to modify and update the data inputted by the medical practitioners. Further, the application server 104 also allows the sharing of the collected data to a plurality of third-party devices. The application server 104 and the handheld device 102 communicate through a communication network. The examples of the communication network include, but are not limited to a telephonic network, a local area network (LAN), a wide area network (WAN), the interact, an intranet, a radio frequency network, and the like.

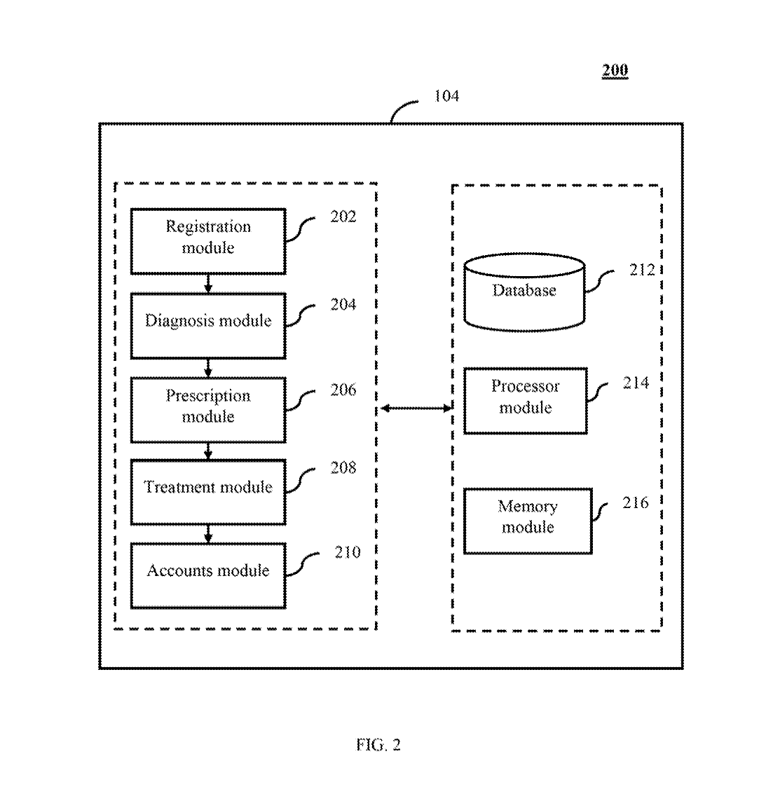

FIG. 2 illustrates a block diagram of an application server for generating personal health records using handheld devices, according to one embodiment herein. The block diagram includes a registration module 202, a diagnosis module 204, a prescription module 206, a treatment module 208, an accounts module 210, and a database 212.

The registration module 202 registers the patient to the patient management system initially. The patient registration is initiated by the hospital staff at the premises of the clinic or the hospital. In other implementation, the patient registration is initiated by the patient. According to an embodiment herein, the registration of the patient is initiated by inputting the details of the patient using the handheld device. The details for registering the patient include, but are not limited to a patient name, the purpose of the visit, type of visit, personal details such as date of birth, contact details, reference details, and the like. Once the details are filled, a registration number is generated for the patient, through which the patient will be identified for further references. Further, the registration module 202 also registers the details of concerned third-party such as a care Over, spouse, parents, children, a pharmacist and the like.

The diagnosis module 204 includes the diagnostic details of the registered patient. According to an embodiment herein, the diagnostic details are collected by the concerned hospital staff. Typically, the diagnostic details are entered before the physician prescribes the medicines to the patient. The diagnostic module 204 further includes the medical history of the patient relevant to the diagnosis and the treatment that has to be provided to the patient. The diagnosis report is tagged with the patient identifier using a handheld device. The process of tagging the diagnosis report is processed using standard methods such as scanning and uploading, linking the report to the patient identifier and the like.

The system further includes a prescription module 206. The prescription module captures and stores the details inputted by the doctor using the handheld device and utilizing the stylus. Typically, the prescription module captures and saves the data as inputted by the doctor. According to an embodiment herein, the prescription module 206 further includes the capabilities such as handwriting recognition and converts the data inputted by the doctors to recognizable digital characters.

The treatment module 208 is configured to track the treatment taken by the patient by consuming prescribed medicines in the prescription. According to an embodiment herein, the treatment module 208 updated by the hospital staff when the patient is admitted as in-patients. According to an embodiment herein, the treatments taken by the patients are updated by the patient or by a caregiver of the patient. The updated treatment list is dynamically linked with the patient identification number. According to an embodiment herein, the treatment module captures the data of the treatment progress either digitally or in the handwriting format.

The accounts module 210 is configured to capture subscription and billing details of the patient. Typically, the, accounts module is maintained by the hospital staff The accounts module 210 is dynamically updated when the patient revisits to meet the medical practitioner and an additional fee has to be made.

The system includes the database 212 for storing a plurality of data related to the patient management system. According to an embodiment herein, the information stored in the database 212 include, but are not limited to documents of the protocols to be followed for each module, rules, and regulations of the hospital, rules and regulations for maintaining the patient management system, metadata, and the like.

According to an embodiment herein, the data captured b various modules are then shared with the concerned third-party. The captured data is shared using a plurality of ways, including b n not limited to messages, e-mail, collaborative document format, app messaging, and the like.

According to an embodiment herein, each of the modules includes an administrator account, a manager account, and a client-side account. The administrator account has the capability to monitor and modify the plurality of accounts created for the patient management system. The manager account has limited capabilities and has the flexibility to monitor and modify the accounts created for a single institution. For example, the manager account A has the capability to monitor and modify the details of the accounts created by the hospital A. The manager account A has the ability to view the details in the form of a dashboard and perform analytics on a plurality of parameters The client-side account is created preferably by the patient and does not have the ability to modify the details without prior permission. The client-side account is primarily used for entering the patient details, receiving the digitized prescription in the handwriting format and updating the treatment details, scheduling further appointments, and contacting the hospital staff Further, the client-side account is used for initiating the payment, for the services received from the hospital or from the independent medical practitioner.

The system further includes a hardware processor 214 for controlling the operation of the application server 104 and process each of the instructions of the application server 104. According to an embodiment herein, the hardware processor 214 has the option to be upgraded and downgraded dynamically. Further, the hardware processor 214 has multiple variations such as single-core, dual-core, multi-core, and the like.

The system includes a memory module 216 configured to store information for immediate use of the application server 104. Typically, the memory module 216 includes a variety of memory such including but not limited to a primary memory, a secondary memory, a semiconductor memory, a cache memory and the like. The memory module 216 also has the option to add virtual memory for managing and upgrading the memory.

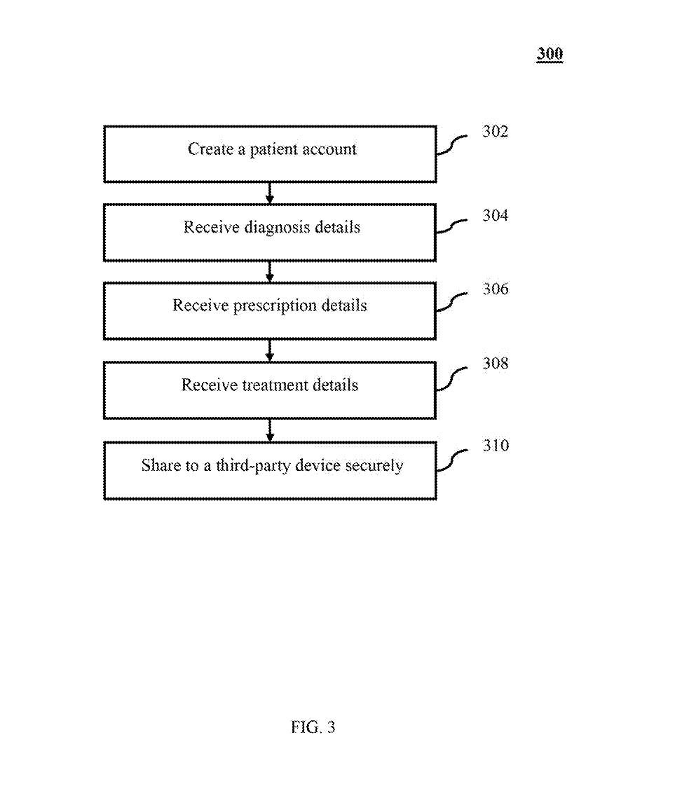

FIG. 3 illustrates a flowchart explaining a method for generating personal health records using handheld devices, according to an embodiment herein. At first, a patient account is created with the patient management system (Step 302). The patient provides the personal details along with the details of the concerned third-party. Once the details are received from the patient, a patient identifier is generated by the patient management system. The generated identifier is used to recognize the patient for further references. The generated identifier includes alphabets, numerals, special characters, or a combination of the above. According to an embodiment herein, the patient identifier is generated using a systematic algorithm. According to an embodiment herein, the patient identifier is generated randomly.

Once the primary details of the patient are received, the patient is sent for the primary diagnosis. The diagnosis report is captured and updated on the diagnosis module (Step 304). According to an embodiment herein, the diagnosis report is updated using the handheld device and is dynamically updated by the hospital staff The diagnosis module farther saves a plurality of versions of the diagnosis and is updated to the patient identity dynamically. According to an embodiment herein, the handheld device allows the hospital staff to pause the application and operate on the other applications such as displaying X-ray from a diagnostic device, and link the same to the diagnostic module with the concerned patient identity. For example, when the hospital staff is diagnosing the patient for primary diagnosis, and when there is a requirement for taking an X-ray, the handheld device is mostly set as a display device, and further the X-ray displayed is linked to the diagnosis report using the patient identity.

Further, the concerned medical practitioner examines the patient and prescribes a plurality of medicines to the patient. The medicine practitioner prescribes the medicines on the application downloaded on the handheld device and inputs the details to the prescription module using the stylus. The details entered by the medical practitioner is in the form of handwriting and is stored in the prescription module (Step 306). Further, the follow-up prescriptions are also captured and is stored in the handwriting format.

Once the prescription details are received, then the patient or the concerned hospital staff is prompted to enter the treatment detail. The treatment details are received by the treatment module for further processing and analysis (Step 308). According to an embodiment herein, the treatment details are updated in both subjective and objective format. The details are updated using the handheld device and is securely stored in the treatment module.

The patient management system allows the patients to share the patient data to the authorized third party (Step 310). The patient data is stored securely in the database and is shared along with the billing and subscription details. According to an embodiment herein, the entire patient management is monitored and administered using the handheld, device.

The embodiments herein provide a method and system for generating personal health records using the handheld device. The embodiments herein provide a method and system to create digitized prescription which is in the form of the handwriting of the medical personnel. The embodiments herein provide a method and system for collaborating the process of patient management. The embodiments herein provide a method and system for sharing the patient data securely with the authorized third-party.

The foregoing description of the specific embodiments will so fully reveal the general nature of the embodiments herein that others can, by applying current knowledge, readily modify author adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A system for generating personal health record using handheld device, the system comprising:
a registration module configured to register a plurality of patients' data using a handheld device, wherein the registration module generates a unique registration number for each patient post registration;
a diagnosis module configured to receive the diagnosis conducted by a medical professional and generate a diagnosis report, wherein the diagnosis report is tagged with the unique registration number of the patient;
a prescription module configured to capture and store a plurality of details including the medicines inputted by the medical professional, wherein the medical professional inputs the plurality of details using the handheld device through a touch interface, wherein the prescription module further includes a handwriting recognition module which converts the details inputted by the medical professional to recognizable digital characters;
a treatment module configured to track a treatment taken by the patients by consuming the prescribed medicines in the prescription, wherein the treatment module provides a treatment list updated by a caregiver, and wherein the updated treatment list is dynamically linked with the unique registration number of the patient;
an accounts module configured to capture subscription and billing details of the patients, wherein the accounts module is maintained by a support team of the medical professional, and wherein the accounts module is dynamically updated when the patient revisits to meet the medical practitioner incurring an additional fee;
a database configured to store a plurality of data related to the patients, the medical professionals, and the support team of the medical professionals, wherein the database is located remotely and is accessed using a plurality of database query techniques.

2. The system according to claim 1, wherein the handheld device is selected from a group consisting of a smartphone, a palmtop, a tablet, a wearable device, a virtual reality device.

3. The system according to claim 1, wherein the registration module is further configured to register the details of concerned third-party such as a caregiver, spouse, parents, children, and a pharmacist.

4. The system according to claim 1, wherein the data is input through the handheld device using an application program, wherein the application program is selected from a group consisting of a mobile application, a web application, an application accessed through a browser, and a native application for the handheld device.

5. The system according to claim 1, wherein the input patients' data includes patient name, the purpose of the visit, type of visit, personal details such as date of birth, contact details, reference details, and the unique registration number.

6. The system according to claim 1, wherein the diagnosis module includes a medical history of the patient relevant to the diagnosis, and wherein the diagnosis report is processed through a plurality of methods, and wherein the plurality of methods is selected from a group consisting of scanning, uploading, typing, and sharing the physical diagnosis report with the database.

7. The system according to claim 1, wherein the information stored in the database includes a plurality of documents of the protocols for each module, rules and regulations of the hospital, rules and regulations for maintaining the patient management system, patient data and the metadata system.

8. The system according to claim 1, wherein the personal health records are shared with a third-party se ices through a plurality of communication channels, wherein the plurality of communication channel comprises messages, e-mail, collaborative document format, push notification, app messaging, and multimedia messaging.

9. The system according to claim 1, wherein the each of the modules includes an administrator account, a manager account, and a client-side account, wherein the administrator account has the capability to monitor and modifies the plurality of accounts created, and the manager account has limited capabilities and has the flexibility to monitor and modify the accounts created for a single institution, and the client-side account and does not have the ability to modify the details without prior permission from the manager account.

10. A computer implemented method comprising instructions stored on a non-transitory computer-readable storage medium and executed on a computing device provided with a hardware processor and a memory for generating a personal health record using a handheld device, the method comprising the steps of:
registering a plurality of patients to an application through a registration module, wherein the registration of the patients includes receiving primary details of the patients and generating a unique patient number;
receiving diagnosis details of the patients through a diagnosis module, wherein the diagnosis is conducted by a medical professional and a diagnosis report is generated, wherein the diagnosis report is tagged with the unique registration number of the patient;
receiving prescription details of the patients from the medical professional through a treatment module, wherein the medical professional inputs the prescription details through a touch interface of the handheld device in a handwritten format, wherein the received prescription details are digitized using handwriting recognition process;
receiving treatment details of the patient from a treatment module from the patient side as a treatment list, wherein the received treatment details are processed and analyzed for monitoring the patients' condition, wherein the treatment list is dynamically linked with the unique registration number of the patient; and,
sharing the generated personal health record to an authorized third-party device securely using a communication medium;
wherein the generated personal health records of the plurality of the patients are stored in a database for further processing and analysis, and wherein the database is a remote database.

11. The method according to claim 10, wherein the method further comprises generating billing and subscription details of the patients using an accounts module, wherein the billing and subscription are updated dynamically based on the visits of the patients' to the medical professionals'.

12. The method according to claim 10 further comprises displaying a plurality of other diagnosis conducted by the medical professional on the handheld device using other applications without causing the patient health record to close.

13. The method according to claim 10 further comprises merging a plurality of diagnosis conducted using the handheld device to the diagnosis details.
